(19) United States
(12) Patent Application Publication
(10) Pub. No.: US 2021/0153421 A1
(43) Pub. Date: May 27, 2021

(54) Devices, Systems And Methods For Seed Trench Monitoring And Closing

(71) Applicant: Ag Leader Technology, Ames, IA (US)

(72) Inventors: Joe Holoubek, Ames, IA (US); Steven Brown, Ames, IA (US); Roger Zielke, Huxley, IA (US); Cody Sobotka, Ames, IA (US); Stuart Helming, Ames, IA (US)

(21) Appl. No.: 17/105,437

(22) Filed: Nov. 25, 2020

Related U.S. Application Data
(60) Provisional application No. 62/940,718, filed on Nov. 26, 2019.

(51) Int. Cl. A01C 5/06; A01B 49/06; A01B 79/00

(52) U.S. Cl. CPC A01C 5/068; A01B 79/005; A01B 49/06; A01C 5/064

(57) ABSTRACT

The disclosed devices, systems and methods relate to agricultural planters, particularly to a two-stage closing system for a planter row unit. In some implementations, the row unit includes a soil engaging member, where the soil engaging member engages at least one sidewall of a trench and displaces soil from the sidewall to cover the seed. In further implementations, the row unit includes a sensing system for sensing sidewall compaction and/or soil moisture.

### CROSS REFERENCE TO RELATED APPLICATIONS

This application claims the benefit under 35 U.S.C. § 119(e) to U.S. Provisional Application 62/940,718, filed Nov. 26, 2019, and entitled “Devices, Systems and Methods for Seed Trench Monitoring and Closing,” which is hereby incorporated herein by reference in its entirety for all purposes.

### TECHNICAL FIELD

The disclosure relates to agricultural planting devices and more specifically to various implementations of a row unit and associated systems and devices including seed trench management systems for use in planting crops, such as corn.

### BACKGROUND

The disclosure relates to agricultural planters, particularly planter row units for use in planting operations of agricultural crops such as corn and soybeans. Currently known planter row units use closing wheels for urging soil into the seed trench to close the trench after seed placement. With these known devices the soil being urged into the seed trench during closing is dry topsoil. Yet, it is understood that surrounding a seed with moist soil creates a better environment for seed germination and plant emergence which may increase overall yield.

There is a need in the art for improved devices, systems, and methods for seed trench opening, closing, and monitoring.

### BRIEF SUMMARY

Described herein are various embodiments relating to devices, systems and methods for seed trench management, including systems for two-stage closing of a trench during agricultural planting and systems for sensing and monitoring trench parameters.

In Example 1 an agricultural planting system including one or more row units, each row unit including a rigid member having at least one soil engaging member shaped to penetrate at least one sidewall of a trench and urge soil over a seed and a least one sensor in operative communication with the at least one soil engaging member, the at least one sensor configured to measure one or more seed trench parameters.

In Example 2 the system of Example 1, where the soil engaging member includes at least one angled portion and where the angled portion penetrates the sidewall of the trench and urges soil from the sidewall of the trench over a seed.

In Example 3 the system of Example 2, where the soil engaging member includes two angled portions such that the soil engaging member penetrates both sidewalls of the trench.

In Example 4 the system of Example 1, where the soil engaging member includes a rotating member disposed at a distal end of the soil engaging member, and where the rotating member is constructed and arranged to penetrate the at least one sidewall.

In Example 5 the system of Example 1, where the at least one sensor measures soil moisture or sidewall compaction.

In Example 6 the system of Example 1, further including a breakaway in operative communication with the soil engaging member such that the soil engaging member reacts to encountering foreign debris without causing damage to the row unit or soil engaging member.

In Example 7 the system of Example 1, where the at least one sensor is a strain gauge.

In Example 8 a row unit including at least one opening disc, a soil engaging member constructed and arranged to penetrate a sidewall of a seed trench and displace soil from a sidewall to cover a seed, and at least one closing disc constructed and arranged to urge soil into the seed trench to close the trench.

In Example 9 the row unit of Example 8, further including a sensing system wherein the soil engaging member includes at least one sensor operatively engaged with the soil engaging member, and wherein the at least one sensor configured to measure at least one of sidewall compaction and soil moisture.

In Example 10 the row unit of Example 9, where the at least one sensor is a moisture sensor.

In Example 11 the row unit of Example 9, where the at least one sensor is a strain gauge.

In Example 12 the row unit of Example 11, where the strain gauge measures the force exerted on the soil engaging member during operation to infer sidewall compaction.

In Example 13 the row unit of Example 12, where the soil engaging member further includes one or more wings configured to engaged with the sidewall.

In Example 14 the row unit of Example 13, where the one or more wings are placed on the soil engaging member such that the one or more wings engage with the sidewall at or near a bottom of a trench.

In Example 15 a planting system including a plurality of row units, each row unit including at least one opening disc configured to open a seed trench, a soil engaging member configured to engage a sidewall of the trench during planting, and at least one strain gauge in operative communication with the soil engaging member, where the at least one strain gauge measures force on the soil engaging member during planting operations.

In Example 16 the planting system of Example 15, where the force on the soil engaging member during planting operations is a measure of sidewall compaction.

In Example 17 the planting system of Example 16, where when excessive sidewall compaction is detected target downforce on the row unit is decreased and when insufficient sidewall compaction is detected target downforce on the row unit is increased.

In Example 18 the planting system of Example 16, where when excessive sidewall compaction is detected supplemental closing wheel downforce is increased and when insufficient sidewall compaction is detected supplemental closing wheel downforce is decreased.

In Example 19 the planting system of Example 15, further including one or more moisture sensors disposed on the soil engaging member, the one or more moisture sensors configured to measure soil moisture.

In Example 20 the planting system of Example 19, wherein a supplemental closing wheel downforce is adjusted based on soil moisture readings.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a cross-sectional view of soil, according to one implementation.

FIG. 2 is a perspective view of an exemplary planter, according to one implementation.

FIG. 3A is a side view of an exemplary row unit, according to one implementation.

FIG. 3B is a side view of an exemplary row unit, according to one implementation.

FIG. 4A is a cross-sectional view of an open seed trench, according to one implementation.

FIG. 4B is a cross-sectional view of a closed seed trench, according to one implementation.

FIG. 5 is a flow diagram of the closing system, according to one implementation.

FIG. 6A is a cross-sectional view of an open seed trench with a soil engaging member, according to one implementation.

FIG. 6B is a cross-sectional view of a partially closed seed trench with a soil engaging member, according to one implementation.

FIG. 6C is a cross-sectional view of a seed trench with a soil engaging member having a rotating member, according to one implementation.

FIG. 7A is a side view of a soil engaging member, according to one implementation.

FIG. 7B is a front view of a soil engaging member, according to one implementation.

FIG. 8 is a top view of a seed trench and closing system, according to one implementation.

FIG. 9A is a side view of a closing system, according to one implementation.

FIG. 9B is a front view of a closing system, according to one implementation.

FIG. 10A is a flow diagram of a sensing system, according to one implementation.

FIG. 10B is a flow diagram of a sensing system, according to one implementation.

### DETAILED DESCRIPTION

Various implementations of the system relate to soil sensing and closing systems for use in row crop planting applications. In various implementations, the disclosed closing system features a two stage closing system providing a soil engaging member, such as a shank or other rigid member, to penetrate the sidewall of the trench and cover the seed with moist soil in the first stage of closing. In the second stage of closing, according to various of the disclosed implementations, the system fills the remainder of the trench with soil. In certain implementations, a soil sensing system is also provided for sensing the soil moisture, side wall compaction, and/or other seed trench parameters of interest to the user or operator, as explained herein.

Certain of the disclosed implementations can be used in conjunction with any of the devices, systems or methods taught or otherwise disclosed in U.S. application Ser. No. 16/121,065, filed Sep. 1, 2018, and entitled “Planter Down Pressure and Uplift Devices, Systems, and Associated Methods,” U.S. Pat. No. 10,743,460, filed Oct. 3, 2018, and entitled “Controlled Air Pulse Metering Apparatus for an Agricultural Planter and Related Systems and Methods,” U.S. application Ser. No. 16/272,590, filed Feb. 11, 2019, and entitled “Seed Spacing Device for an Agricultural Planter and Related Systems and Methods,” U.S. application Ser. No. 16/142,522, filed Sep. 26, 2018, and entitled “Planter Downforce and Uplift Monitoring and Control Feedback Devices, Systems and Associated Methods,” U.S. application Ser. No. 16/280,572, filed Feb. 20, 2019 and entitled “Apparatus, Systems and Methods for Applying Fluid,” U.S. application Ser. No. 16/371,815, filed Apr. 1, 2019, and entitled “Devices, Systems, and Methods for Seed Trench Protection,” U.S. application Ser. No. 16/523,343, filed Jul. 26, 2019, and entitled “Closing Wheel Downforce Adjustment Devices, Systems, and Methods,” U.S. application Ser. No. 16/670,692, filed Oct. 31, 2019, and entitled “Soil Sensing Control Devices, Systems, and Associated Methods,” U.S. application Ser. No. 16/684,877, filed Nov. 15, 2019, and entitled “On-The-Go Organic Matter Sensor and Associated Systems and Methods,” U.S. application Ser. No. 16/752,989, filed Jan. 27, 2020, and entitled “Dual Seed Meter and Related Systems and Methods,” U.S. application Ser. No. 16/891,812, filed Jun. 3, 2020, and entitled “Apparatus, Systems, and Methods for Row Cleaner Depth Adjustment On-The-Go,” U.S. application Ser. No. 16/921,828, filed Jul. 6, 2020, and entitled “Apparatus, Systems and Methods for Automatic Steering Guidance and Visualization of Guidance Paths,” U.S. application Ser. No. 16/939,785, filed Jul. 27, 2020, and entitled “Apparatus, Systems and Methods for Automated Navigation of Agricultural Equipment,” U.S. application Ser. No. 16/997,361, filed Aug. 19, 2020, and entitled “Apparatus, Systems, and Methods for Steerable Toolbars,” U.S. application Ser. No. 16/997,040, filed Aug. 19, 2020, and entitled “Adjustable Seed Meter and Related Systems and Methods,” U.S. application Ser. No. 17/011,737, filed Aug. 3, 2020, and entitled “Planter Row Unit and Associated Systems and Methods,” and U.S. application Ser. No. 17/060,844, filed Oct. 1, 2020, and entitled “Agricultural Vacuum and Electrical Generator Devices, Systems, and Methods,” each of which is incorporated herein.

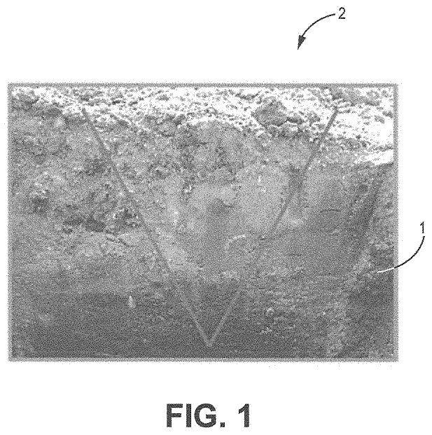

FIG. 1 depicts a cross section of soil 1 and further depicts the cut of a typical trench 2. It is appreciated by those of skill in the art that the moisture in such soil 1 typically increases with increased trench 2 depth. Surrounding seeds with moister soil 1—such as that drawn from lower in the trench 2—can improve seed germination and plant emergence and thereby increase overall yield. The various implementations of closing devices, methods and systems disclosed herein relate to technologies directed to the closing of an open trench and improving yield by causing deeper—and therefore moister—soil 1 to surround the planted seeds.

In various implementations of the closing system disclosed herein, a soil engaging member, such as a shank or other rigid member, is utilized to surround the seeds with moist soil.

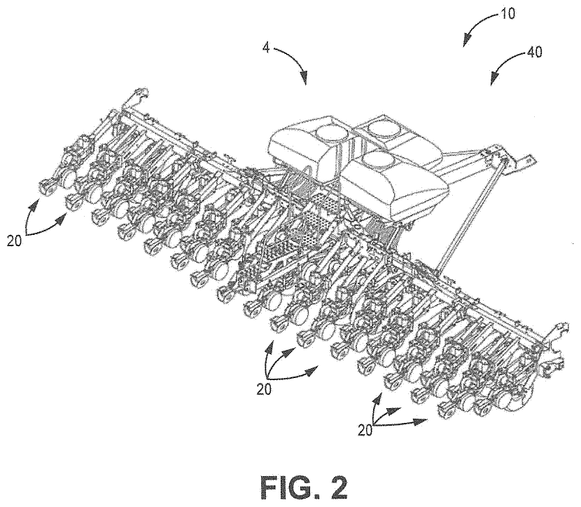

Turning to the figures in greater detail, FIG. 2 depicts a planter 4 fitted with an exemplary implementation of the disclosed closing system 10. Such implementations of the closing system are adapted to operate with such a planter 4 that includes a plurality of row units 20 constructed and arranged for planting row crops such as corn, optionally at high speed.

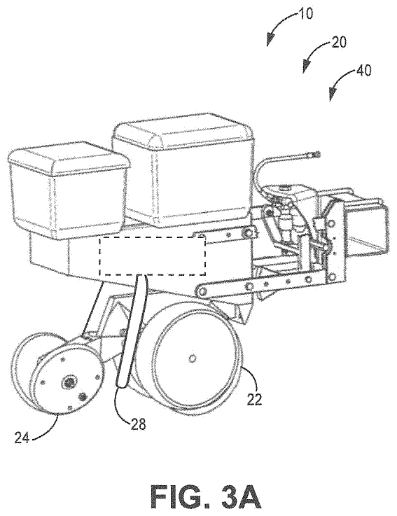

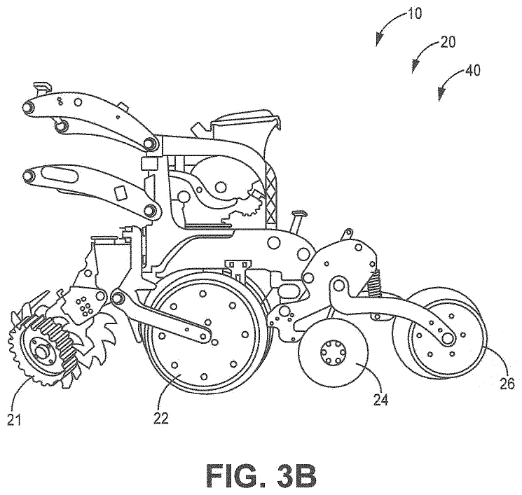

Various configurations of row units 20 are known in the art and exemplary row units 20 are shown in FIGS. 3A and 3B. It would be appreciated by those of the skill in the art that the various devices, systems, and methods disclosed and contemplated herein may be used in connection with any row unit 20.

Continuing with the row units 20 of FIGS. 3A-3B, seed trenches 2 are typically formed in soil by various components on those row units 20. In exemplary implementations, the seed trench 2 is formed by opening discs 22 disposed on the row unit 20, shown for example in FIGS. 3A and 3B. In further implementations, the seed trench 2 is closed via a closing wheel 24 or pair of closing wheels 24.

In yet further implementations, the closed trench 2 may be further closed/firmed/pressed via a press wheel 26 or other implements such as a firmer (not shown). In certain implementations, row cleaners 21 are disposed on the row unit 20 for clearing debris and/or foreign matter from the path of the row unit 20, as shown in FIG. 3B.

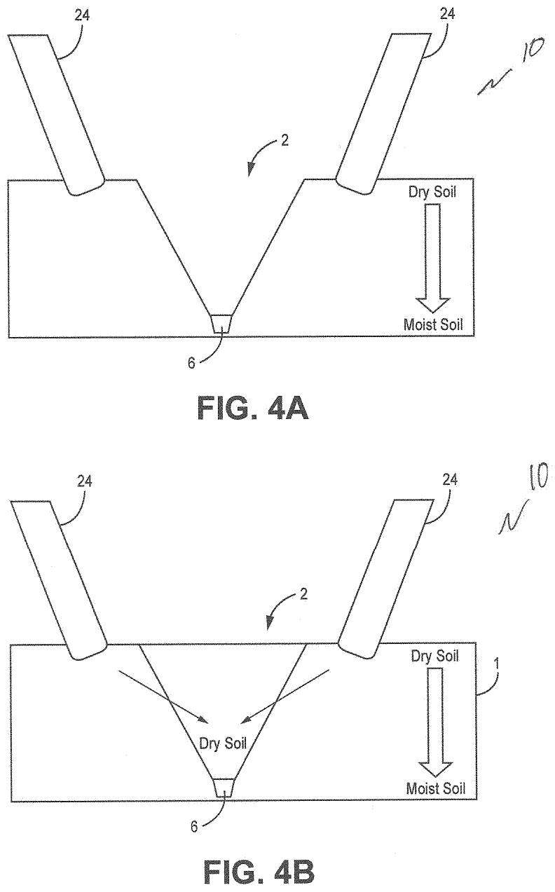

Turning now to FIGS. 4A and 4B, known closing systems cover a seed 6 with dry soil 1. In these known systems, the closing wheel(s) 24 operate such as to urge the soil 1 that was displaced during trench opening back into the trench 2 to cover the seed 6. The soil 1 that is displaced during trench opening is typically dry topsoil 1. It is understood that dry soil 1 does not create an ideal environment for plant emergence and/or seed germination. Additionally, the soil 1 displaced during trench opening may contain debris and other foreign material that may inhibit seed germination and/or obstruct plant emergence thereby reducing overall yield, as would be understood.

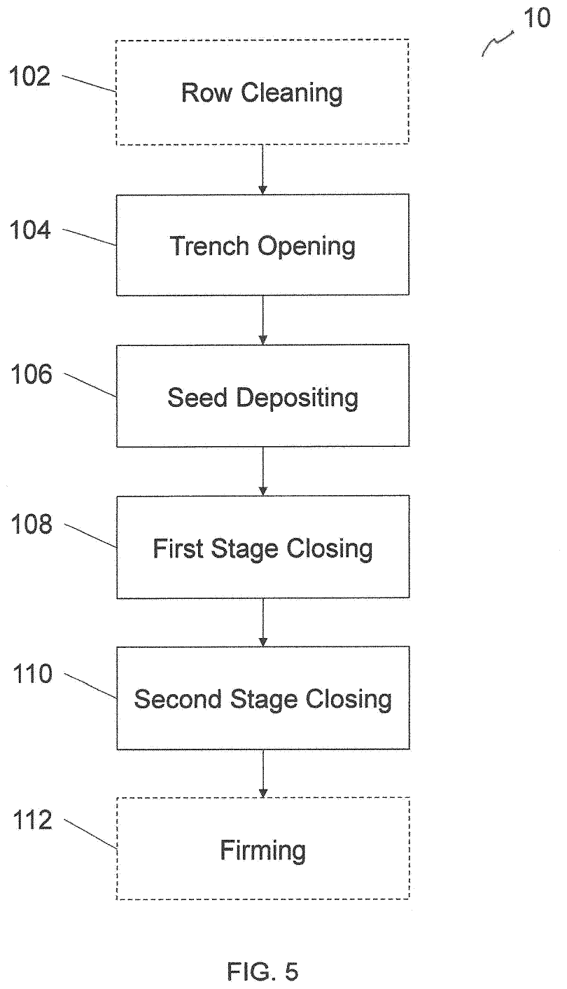

Turning now to FIG. 5, certain implementations feature a two-stage closing system 10 comprising a variety of optional steps and sub-steps. In various illustrative implementations, in one step the row unit 20 opens the trench (box 104) and a seed is placed in the trench (box 106) via any opening and/or planting mechanism as would be understood. In a further step, the row unit 20 utilizes a soil engaging member 30 (discussed further below) to partially close the trench in first stage closing step (box 108). During the first stage closing step (box 108), moist soil from deep in the trench sidewall is pulled into the trench and over the seed providing a moist environment for seed germination, as would be readily appreciated.

In a further step, the trench is fully closed during a second stage closing step (box 110). Those of skill in the art would appreciate that during the second stage closing step (box 110), any remaining cavity in the trench is filled with soil. Various mechanisms are known for this second stage closing step (box 110) and would be appreciated by those of skill in the art, such as but not limited to one or more closing wheels, one or more closing discs, a firming wheel, and/or a drag chain.

In certain implementations, the row unit 20 optionally includes a row cleaner (shown at 21 in FIG. 3B) to clean debris from the path of the row unit 20 during the planting step (box 102). In further implementations, the closing system 10 optionally includes a firming step (box 112) where after the trench is fully closed a press wheel (shown in 26 in FIG. 3B) or other appreciated mechanism firms the soil.

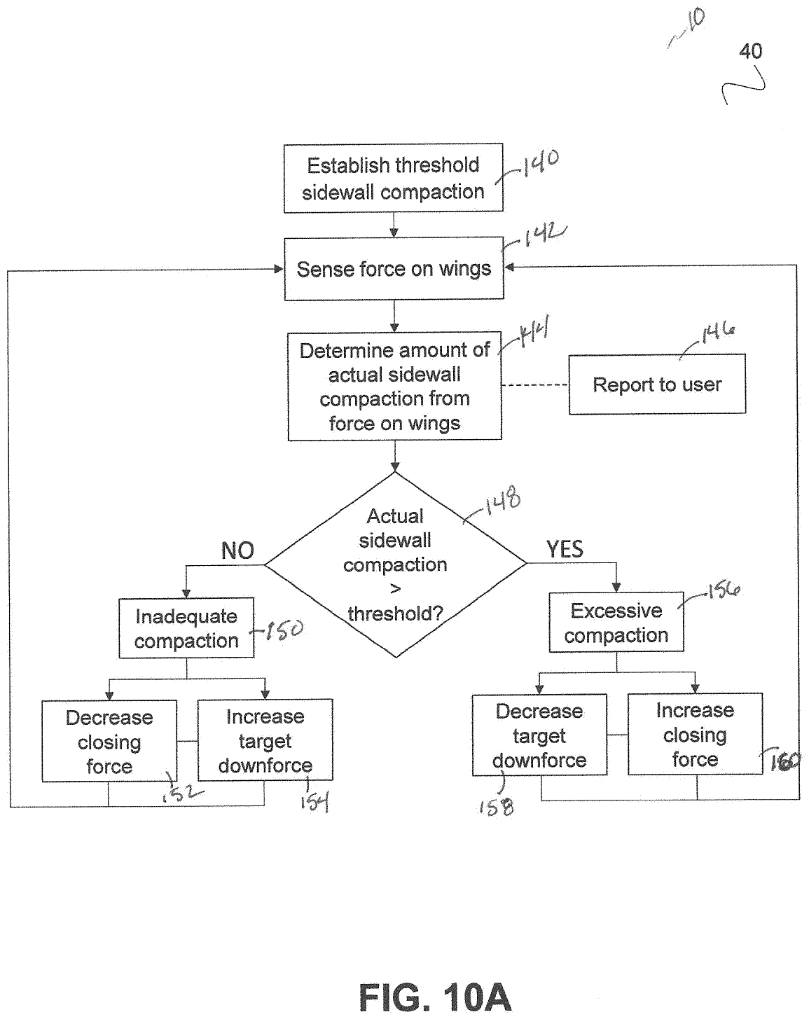

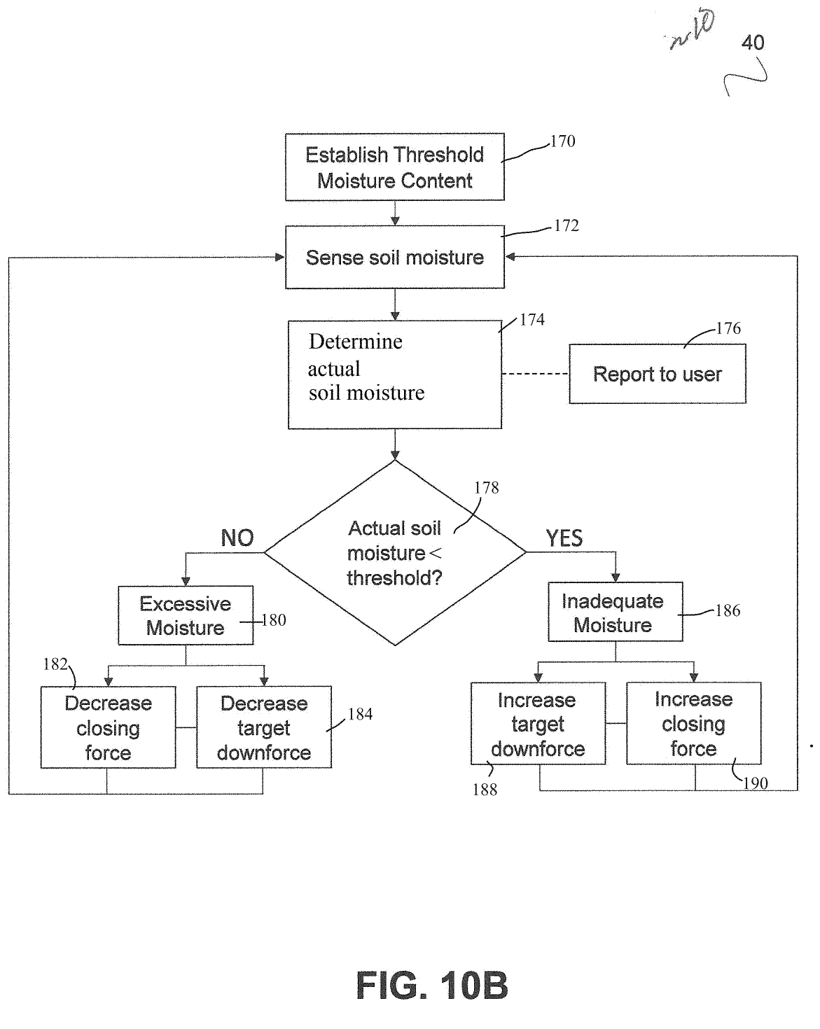

As noted above, in various implementations of the closing system 10 disclosed and contemplated herein, the planter row unit 20 includes a soil engaging member 30 constructed and arranged to cover the seed 6 with moist soil 1, from within the trench 2 sidewall, without displacement of the seed 6. In various additional implementations, the planter row unit 20 includes a sensing system 40 to sense soil moisture and/or trench sidewall compaction, as discussed further below in relation to FIGS. 10A and 10B.

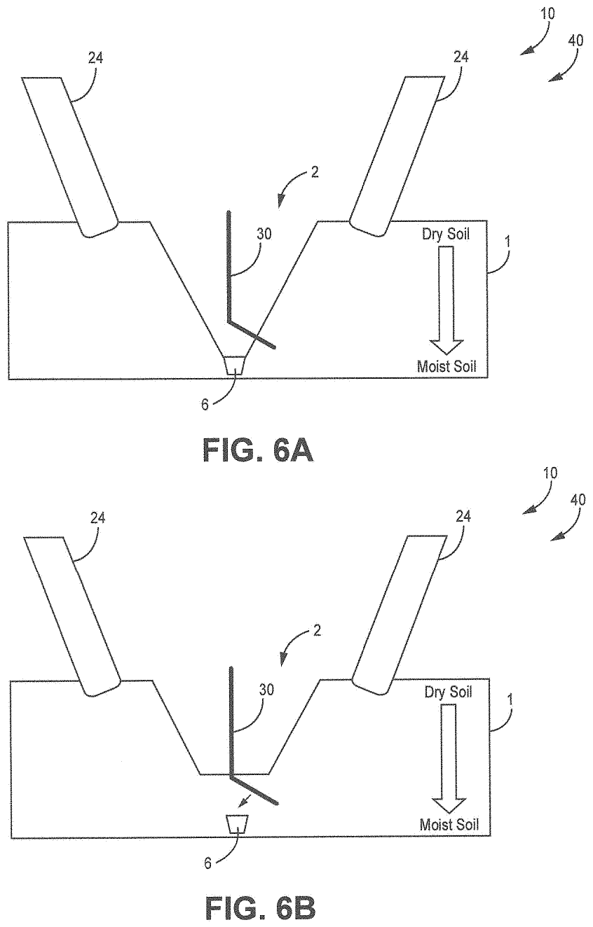

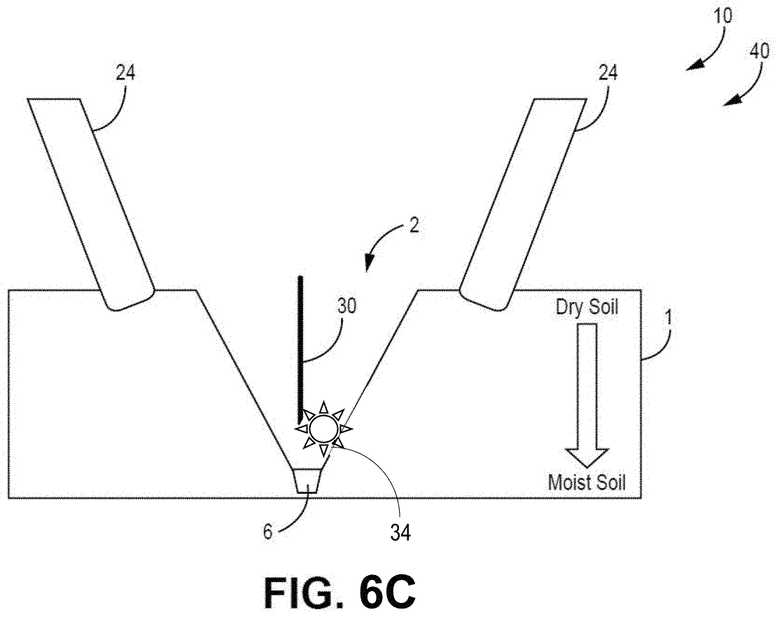

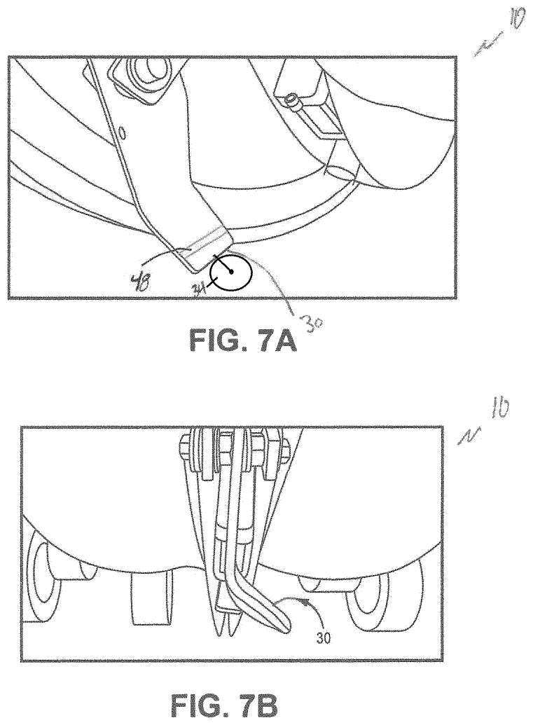

FIGS. 6A-C depict a partial trench 2 closure step, also referred to as the first stage closing step, via the soil engaging member 30. The soil engaging member 30 is constructed and arranged such that the distal end of the soil engaging member 30 is angled and penetrates the sidewall of the trench 2 in order to urge soil 1 from the sidewall of the trench 2 over the seed 6. FIGS. 7A and 7B depict exemplary implementations of a soil engaging member 30. In some alternative implementations, the soil engaging member 30 includes two flared ends (also referred to as wings) disposed on opposite sides and arranged to penetrate both sidewalls of the trench 2.

In these and other implementations, the soil engaging member 30 has a geometry such that the moist soil 1 at or near the bottom of the trench 2 sidewall is displaced to cover a seed 6 without displacing the seed 6. The partial closure of the seed trench 2—the first-stage closure, shown in FIG. 6B—is followed by full/complete closure of the seed trench 2 by the row unit 20—the second stage closure. In various implementations, during second stage closure the closing wheel(s) 24 urge soil 1 into the seed trench 2 to fill the remainder of the seed trench 2. In various implementations, the row unit 20 includes a press wheel 26 to firm the soil trench behind the row unit 20 after second stage closing.

It is appreciated that the closing system 10 ensures that the seed 6 is surrounded by moist soil 1 that is free from debris thereby improving seed germination and plant emergence and increasing overall yield.

In some implementations, the soil engaging member 30 may also include a breakaway or other detachment device to allow the shank 30 to react when encountering rocks or other debris such that the soil engaging member 30 does not break or cause the row unit 20 to stop. Additionally, in various implementations, the soil engaging member 30 is constructed such that it can pass through residue.

In certain implementations, as shown in FIG. 6C and 7A, the soil engaging member 30 may include a rotating member 34 on the distal end of the soil engaging member 30. In certain implementations, the rotating member 34 may be a disc (as shown for example in FIG. 7A) or spiked wheel (as shown for example in FIG. 6C), or any other suitable component understood in the art. In various implementations the rotating member 34 is constructed and arranged to scrap moist soil from the sidewall of the trench over the seed.

In various implementations, the soil engaging member 30—with or without a rotating member 34—may be instrumented to measure soil moisture on-the-go, as shown in FIG. 7A. In these and other implementations, the soil engaging member 30 includes one or more soil moisture sensors 48. In various implementations, the soil moisture sensor may be an optical sensor, capacitive sensor, or other sensor type appreciated by those of skill in the art. Such on-the-go soil moisture measurements may be used as feedback for an automatic planting depth control system, as discussed in U.S. Patent 9,629,304 which is hereby incorporated by reference.

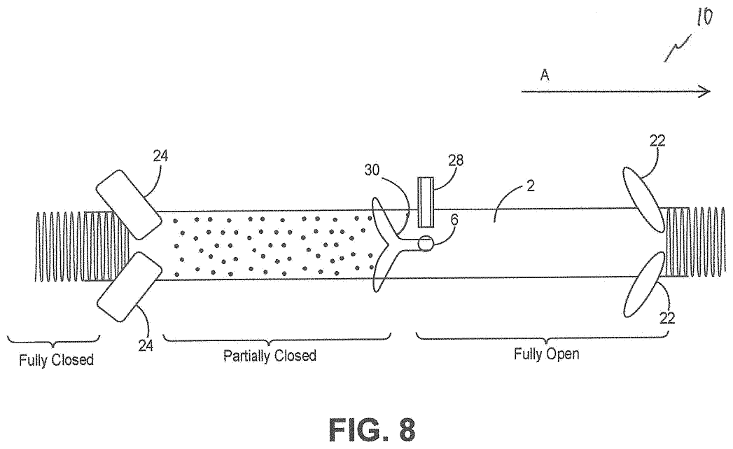

FIG. 8 shows a schematic depiction of the closing system 10 in use, where the planter is traveling in the direction of reference arrow A. In these implementations, the opening discs 22 fully open the seed trench 2. A seed tube 28 or other deposition mechanism deposits a seed 6 into the trench 2. As the row unit 20 traverses the soil the soil engaging member 30 penetrates the sidewall of the trench 2 partially closing the trench 2—first stage closing—coving the seed 2 with moist soil 1. Next, the closing wheels 24 then urge additional soil 1 into the trench 2 fully closing the trench 2—second stage of closing. In some implementations, the fully closed seed trench 2 is optionally firmed with a press wheel 26, as would be understood.

In some implementations, the closing system 10 may include a firming device disposed behind the soil engaging member 30 to firm the moist soil 1 after the first stage of closure prior to the second stage of closure. The firming device presses the moist soil 1 on top of the seed 6 to ensure contact between the seed and the moist soil 1.

In various implementations, the closing system 10 and soil engaging member 30 may be constructed and arranged to condition the soil 1 before it is urged over the seed 6 during the first stage of closure.

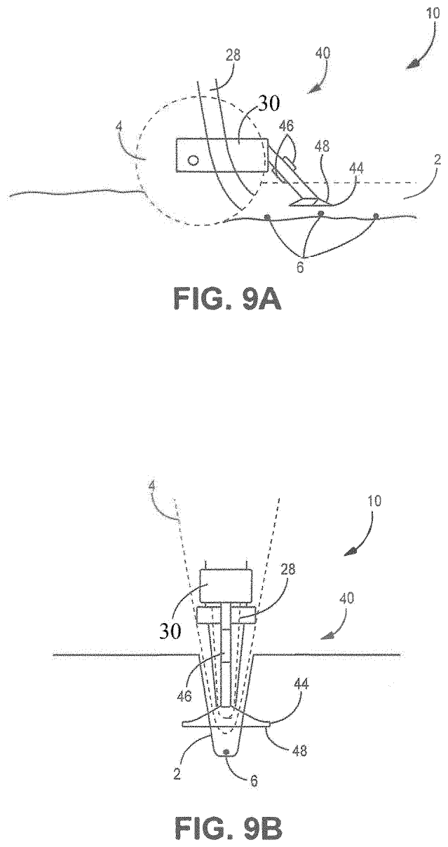

Some implementations of the closing system 10 include a sensing system 40, as shown in FIGS. 9A and 9B. In these and other implementations, the closing system 10 includes either or both of a soil engaging member 30, described above, and a sensing system 40. In various implementations, the sensing system 40 is constructed and arranged to sense soil moisture, side wall compaction, and/or other seed trench 2 parameters of interest to those of skill in the art.

In certain implementations, the sensing system 40 includes the soil engaging member 30, discussed above, where a soil engaging member 30 may extend into the seed trench 2 behind the seed tube 28.

In various implementations, the soil engaging member 30 includes wings 44 at its distal end. The wings 44 may protrude from the soil engaging member 30 such as to engage both sidewalls of the seed trench 2 during planting. In alternative implementations, the soil engaging member 30 may only include one wing 44 penetrating only one sidewall of the trench 2. In some implementations, the soil engaging member 30 extends deep into the seed trench 2 such that the wing(s) 44 engage the sidewall(s) of the trench 2 close to or near the bottom of the trench 2. In some implementations, the wings 44 are the distal and/or flared ends of the soil engaging member 30, described above.

In various implementations, during planting operations the wing(s) 44 are pulled through the seed trench 2 sidewall(s). In certain of these implementations, the soil engaging member 30 may include one or more strain gauges 46 or other sensors to determine the amount of force exerted on the wings 44 as they are pulled through the sides of the trench 2. That is, in various implementations, the strain gauges 46 determine the amount of force required to pull the soil engaging member 30 through the sidewall of the trench. In certain of these implementations, the strain gauge 46 reading may be used as an indicator of the amount of sidewall compaction.

The amount of sidewall compaction is an important factor to farmers, operators, and other stakeholders as the amount of sidewall compaction may be an indicator the proper amount of target row unit 20 downforce necessary to maintain planting depth. As would be appreciated, ideal downforce on the row unit 20 creates just enough sidewall compaction to hold the integrity of the trench 2, but does not cause excessive sidewall compaction. Excessive downforce and/or sidewall compaction can lead to poor germination and poor seedling roots, reducing overall yield.

The amount of sidewall compaction can be affected by a number of factors, including but not limited to heavy tractors, bulk fill planters, wet soil, excessive downforce, tire compaction from previous passes, and/or prior tillage passes such as during seed bed preparation.

The sensing system 40 may inform the operator of the amount of sidewall compaction and thereby influence adjustment to the target downforce on the row unit 20. In various implementations, feedback from the sensing system 40 may allow an operator to manually set and/or adjust the target downforce. In various alternative implementations, the sensing system 40 may automatically adjust the target downforce.

As noted above, in various additional implementations, the sensing system 40, strain gauge 46 feedback and/or sidewall compaction readout may be used to adjust supplemental downforce to the closing wheel(s) 24. As the amount of force to break the sidewall of the trench 2 increases so does the force necessary to properly close the trench 2. As such, the sensing system 40 may allow for automatic or manual adjustments to the amount of supplemental force applied to the closing wheel 24.

In some implementations, the wings 44 of the sensing system 40 include moisture sensors 48. In various implementations, the moisture sensors 48 are constructed and arranged to sense the amount of moisture in the soil 1 at the level of the wings 44. As such, the moisture sensors 48 determine how moist the soil 1 is when the trench 2 is being formed.

In various implementations, the sensing system 40 may then send feedback to the operator and/or other systems—such as the closing system 10—within the planter 4 to allow for adjustments to be made. For example, in certain implementations, dry soil 1 requires more downforce than wet soil 1 to achieve proper trench 2 formation and closure. The sensing system 40 may send feedback to the operator and/or other systems on the planter 4 to manually and/or automatically adjust the amount of downforce applied to the row unit based on the moisture reading. Of course, in certain situations, the system can also be configured to assert more downforce when soil moisture increases. In another example, the moisture reading may allow for adjustments in planting depth, either manual or automatic, such that the seed 6 is planted in moist soil 1.

In various implementations, the sensing system 40 may utilize both the amount of soil moisture in the trench along with the amount of sidewall compaction to optimize the amount of supplemental closing force and/or the amount of target downforce to maximize yields. In certain of these implementations, the moisture and/or sidewall compaction can be assessed via a combination of sensors and algorithmic processing, as described herein. In use according to these implementations, the sensing system 40 evaluates ground data to provide on-the-go feedback for use in making adjustments to various planting parameters such as, for example, applied downforce.

In certain implementations of the closing system 10, a sensing system 40 is utilized to evaluate planting parameters to optimize various other systems in connection with the system 10. The sensing system may evaluate parameters including but not limited to target downforce, supplemental closing wheel force, planting depth, and operating speed, among others, as would be readily appreciated.

In various implementations, the sensing system 40 utilizes one or more sensors described herein and executes several steps, where each step in optional and may be performed in any order.

For example, as shown in FIG. 10A, in various implementations a threshold for sidewall compaction or force (box 140) is established. In various implementations, the threshold value is entered manually by a user, retrieved from previous passes and/or data, or otherwise acquired by the system, such as via logic, artificial intelligence or machine learning techniques.

In a further optional step, the system 40 utilizes a force sensor such as a strain gauge (shown in FIGS. 9A-9B at 46) or other sensor to determine the amount of force on the one or more above-described wings (box 142—shown at 44 in FIGS. 9A-9B). It is readily appreciated that in certain of these implementations, the recorded force from the strain gauge or other force sensor can comprise information relating to direction of travel and draft force, among other data points, as would be readily appreciated.

For example, in one such implementation the strain gauge 46 records an amount of draft force, such as in pounds, recorded at the wing (box 142) which can be used by the system to estimate the amount of sidewall compaction (box 144) via system logic and/or algorithmic processing, as would be understood.

In certain implementations, the amount of compaction is reported to a user (box 14). In certain implementations, the sensing system 40 is in electronic communication with a display to give a user feedback regarding the sidewall compaction and/or soil moisture on-the-go, as would be readily appreciated and is frequently described in the incorporated references.

In a further optional step, the system 40 compares the actual sensed force and/or sidewall compaction (from boxes 142 and/or 144) with the threshold value (148). In certain implementations, when the sensing system 40 senses inadequate sidewall compaction (box 150) or excessive sidewall compaction (box 156) the system 40 makes automatic adjustments or prompts a user to make manual adjustments to various operating parameters, such as applied downforce and speed.

For example, when inadequate sidewall compaction (box 148) is sensed under certain implementations of the system 40, characterized for example by the actual sidewall compaction being less than an established threshold value (box 150), the amount of supplemental closing force may be decreased (box 152) and/or the amount of target downforce may be increased (box 154).

When excessive compaction is sensed (box 156), characterized in certain implementations by the actual sidewall compaction being greater than the threshold value (box 156), the amount of target downforce may be decreased (box 158) and/or the amount of supplemental closing force may be increased (box 160).

Turning to FIG. 10B, in various implementations, the sensing system 40 utilizes soil moisture values as a parameter within the system 40. In various implementations, the system 40 may integrate the parameters of soil moisture and sidewall compaction/force together, as would be appreciated.

In one optional step, the system 40 establishes a threshold for soil moisture (box 170). In various implementations, the threshold value is entered manually by a user, retrieved from previous passes and/or data, or otherwise acquired by the system, such as via logic, artificial intelligence or machine learning techniques.

In a further optional step, the system 40 utilizes optical and/or capacitive sensors (shown in FIGS. 7A and 9A-B at 48) or other suitable sensors to sense the amount of moisture in the soil (box 172).

In various implementations, the sensed soil moisture, such as in a percentage, recorded at the wing (box 172) is used to determine the actual soil moisture (box 174). In certain implementations, the actual soil moisture is reported to a user (box 176) via any method or mechanism as would be understood by those of skill in the art. In certain implementations, the sensing system 40 is in electronic communication with a display to give a user feedback regarding the soil moisture on-the-go.

In a further optional step, the system 40 compares the actual soil moisture (from box 174) with the threshold value (box 178). In certain implementations, when the sensing system 40 senses excessive moisture (box 180) or inadequate moisture (box 186) the system 40 makes automatic adjustments or prompts a user to make manual adjustments to various operating parameters, such as applied downforce, speed, and planting depth.

When excessive soil moisture is sensed (box 180), characterized in certain implementations by the actual soil moisture being greater than the threshold value (box 180), the amount of supplemental closing force may be decreased (box 182) and/or the amount of target downforce may be decreased (box 184).

When inadequate moisture is sensed (box 186), characterized in certain implementations by the actual soil moisture being less than the threshold value (box 186), the amount of target downforce may be increased (box 188) and/or the amount of supplemental closing force may be increased (box 190).

Although the disclosure has been described with reference to preferred embodiments, persons skilled in the art will recognize that changes may be made in form and detail without departing from the spirit and scope of the disclosed apparatus, systems and methods.

What is claimed is:

1. An agricultural planting system comprising:
one or more row units, each row unit comprising:
(a) a soil engaging member shaped to penetrate at least one sidewall of a trench and urge soil over a seed; and
(b) a least one sensor in operative communication with the at least one soil engaging member, the at least one sensor configured to measure one or more seed trench parameters.

2. The system of claim 1, wherein the soil engaging member includes at least one angled portion and wherein the angled portion penetrates the sidewall of the trench and urges soil from the sidewall of the trench over a seed.

3. The system of claim 2, wherein the soil engaging member includes two angled portions such that the soil engaging member penetrates both sidewalls of the trench.

4. The system of claim 1, wherein the soil engaging member comprises a rotating member disposed at a distal end of the soil engaging member, and wherein the rotating member is constructed and arranged to penetrate the at least one sidewall.

5. The system of claim 1, wherein the at least one sensor measures soil moisture or force.

6. The system of claim 1, further comprising a breakaway in operative communication with the soil engaging member such that the soil engaging member reacts to encountering foreign debris without causing damage to the row unit or soil engaging member.

7. The system of claim 1, wherein the at least one sensor is a strain gauge.

8. A row unit comprising:
(a) at least one opening disc;
(b) a soil engaging member constructed and arranged to penetrate a sidewall of a seed trench and displace soil from a sidewall to cover a seed; and
(c) at least one closing disc constructed and arranged to urge soil into the seed trench to close the trench.

9. The row unit of claim 8, further comprising a sensing system comprising at least one sensor operatively engaged with the soil engaging member, wherein the at least one sensor configured to measure at least one of sidewall compaction and soil moisture.

10. The row unit of claim 9, wherein the at least one sensor is a soil moisture sensor.

11. The row unit of claim 9, wherein the at least one sensor is a strain gauge.

12. The row unit of claim 11, wherein the strain gauge measures the force exerted on the soil engaging member during operation to infer sidewall compaction.

13. The row unit of claim 12, wherein the soil engaging member further comprises one or more wings configured to engage with the sidewall.

14. The row unit of claim 13, wherein the one or more wings are placed on the soil engaging member such that the one or more wings engage with the sidewall at or near a bottom of a trench.

15. A planting system comprising a plurality of row units, each row unit comprising:
(a) at least one opening disc configured to open a seed trench;
(b) a soil engaging member configured to engage a sidewall of the trench during planting; and
(c) at least one strain gauge in operative communication with the soil engaging member,
wherein the at least one strain gauge measures force on the soil engaging member during planting operations.

16. The planting system of claim 15, wherein the force on the soil engaging member during planting operations is a measure of sidewall compaction.

17. The planting system of claim 16, wherein when excessive sidewall compaction is detected target downforce on the row unit is decreased and when insufficient sidewall compaction is detected target downforce on the row unit is increased.

18. The planting system of claim 16, wherein when excessive sidewall compaction is detected supplemental closing wheel force is increased and when insufficient sidewall compaction is detected supplemental closing wheel force is decreased.

19. The planting system of claim 15, further comprising one or more moisture sensors disposed on the soil engaging member, wherein the one or more moisture sensors is configured to measure soil moisture.

20. The planting system of claim 19, wherein a supplemental closing wheel force is adjusted based on soil moisture readings.
